(19) United States
(12) Patent Application Publication
(10) Pub. No.: US 2026/0292288 A1
(43) Pub. Date: Sep. 24, 2026

(54) METHOD AND APPARATUS FOR SYNCHRONIZING AUDIO STREAM AND VIDEO STREAM, AND DEVICE, MEDIUM AND PRODUCT

(71) Applicant: Beijing Zitiao Network Technology Co., Ltd., Beijing (CN)

(72) Inventors: Chaoyang GUO, Beijing (CN); Zhixin WU, Beijing (CN)

(21) Appl. No.: 19/577,227

(22) Filed: Mar. 24, 2026

(30) Foreign Application Priority Data
Mar. 24, 2025 (CN) 202510353838.7

(51) Int. Cl. H04N 21/43; H04N 21/262; H04N 21/8547

(52) U.S. Cl. CPC H04N 21/43072; H04N 21/2625; H04N 21/8547

(57) ABSTRACT

Embodiments of the present disclosure relate to a method, an apparatus, a device, a medium, and a product for synchronizing an audio stream and a video stream. The method includes determining a target audio frame in an audio stream to be sent. The method further includes determining a set of durations corresponding to a set of historical video frames in a video stream, the set of historical video frames being generated based on a set of historical audio frames in the audio stream. The method further includes determining a delay duration for the target audio frame based on the set of durations. The method further includes keeping the audio stream and the video stream synchronized by delaying the target audio frame by the delay duration.

### CROSS-REFERENCE TO RELATED APPLICATIONS

This application claims priority to Chinese Application No. 202510353838.7 filed Mar. 24, 2025, the disclosure of which is incorporated herein by reference in its entirety.

### TECHNICAL FIELD

Embodiments of the present disclosure generally relate to the field of audio and video processing, and in particular, to a method and an apparatus for synchronizing an audio stream and a video stream, and a device, a medium, and a product.

### BACKGROUND

At present, with the rapid development of real-time communication technologies and multimedia stream transmission technologies, there are an increasing number of application scenarios in which audio and video are processed separately at different sources, merged, and then pushed to an audience side. For example, in live streaming, virtual conferences, and remote interactions, video and audio usually come from different production ends, where the audio may be uploaded by a participant through real-time communication, and the video may be generated through cloud rendering or remote acquisition.

In the process of audio and video processing, the audio and video processing links may be different, but the data passing through these links may be integrated into a complete data stream and provided to users. Thus, users may see multimedia content with synchronized sound and pictures that complement each other through user terminal devices such as mobile phones, computers, and smart TVs, to obtain an all-round audio-visual experience.

### SUMMARY

Embodiments of the present disclosure provide a method and an apparatus for synchronizing an audio stream and a video stream, and a device, a medium, and a product.

According to a first aspect of the present disclosure, there is provided a method for synchronizing an audio stream and a video stream. The method includes determining a target audio frame in an audio stream to be sent. The method further includes determining a set of durations corresponding to a set of historical video frames in a video stream, the set of historical video frames being generated based on a set of historical audio frames in the audio stream. The method further includes determining a delay duration for the target audio frame based on the set of durations. The method further includes keeping the audio stream and the video stream synchronized by delaying the target audio frame by the delay duration.

According to a second aspect of the present disclosure, there is provided an apparatus for synchronizing an audio stream and a video stream. The apparatus includes a target audio frame determination module configured to determine a target audio frame in an audio stream to be sent; a set of durations determination module configured to determine a set of durations corresponding to a set of historical video frames in a video stream, the set of historical video frames being generated based on a set of historical audio frames in the audio stream; a delay duration determination module configured to determine a delay duration for the target audio frame based on the set of durations; and a synchronization module configured to keep the audio stream and the video stream synchronized by delaying the target audio frame by the delay duration.

In a third aspect of the present disclosure, there is provided an electronic device, including at least one processor; and a storage apparatus, configured to store at least one program, where the at least one program, when executed by the at least one processor, causes the at least one processor to implement the method according to the first aspect of the present disclosure.

In a fourth aspect of the present disclosure, there is provided a computer-readable storage medium having a computer program stored thereon, wherein the computer program, when executed by a processor, implements the method according to the first aspect of the present disclosure.

In a fifth aspect of the present disclosure, there is provided a computer program product. The computer program product includes a computer program that, when executed by a processor, implements the method according to the first aspect of the present disclosure.

It should be understood that the content described in this content section is not intended to limit key or important features of the embodiments of the present disclosure, and is also not intended to limit the scope of the present disclosure. Other features of the present disclosure will become readily comprehensible through the following description.

### BRIEF DESCRIPTION OF THE DRAWINGS

The foregoing and other objectives, features, and advantages of the present disclosure become more apparent by describing the exemplary embodiments of the present disclosure in more detail with reference to the drawings, where in the exemplary embodiments of the present disclosure, the same reference numerals generally represent the same components.

FIG. 1 is a schematic diagram of an example environment in which a device and/or a method according to some embodiments of the present disclosure may be implemented;

FIG. 2 is a schematic diagram of an example method for synchronizing an audio stream and a video stream according to some embodiments of the present disclosure;

FIG. 3 is a schematic diagram of an example method for updating a duration according to some embodiments of the present disclosure;

FIG. 4 is a schematic diagram of an example method of a lip movement generation link according to some embodiments of the present disclosure;

FIG. 5 is a schematic diagram of another example method of a lip movement generation link according to some embodiments of the present disclosure;

FIG. 6 is a schematic block diagram of an apparatus for synchronizing an audio stream and a video stream according to some embodiments of the present disclosure; and

FIG. 7 is a schematic block diagram of an example device suitable for implementing multiple embodiments of the present disclosure.

### DETAILED DESCRIPTION OF EMBODIMENTS

It may be understood that the data involved in the technical solution (including but not limited to the data itself, acquisition or use of the data) shall comply with requirements of corresponding laws, regulations, and related provisions.

It may be understood that before the use of the technical solutions disclosed in the embodiments of the present disclosure, the user shall be informed of the type, range of use, use scenarios, etc., of personal information involved in the present disclosure and the authorization of the user shall be obtained in an appropriate manner in accordance with relevant laws and regulations.

For example, when an active request from a user is received, prompt information is sent to the user to clearly inform the user that the requested operation will require access to and use of the user’s personal information. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to receiving the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It may be understood that the above process of notifying the user and acquiring the authorization of the user is only illustrative and does not constitute a limitation on the implementations of the present disclosure, and other manners that satisfy the relevant laws and regulations may also be applied in the implementations of the present disclosure.

The embodiments of the present disclosure are described in more detail below with reference to the drawings. The drawings illustrate some embodiments of the present disclosure, but it should be understood that the present disclosure may be implemented in various forms and should not be construed as limited to the embodiments set forth herein; on the contrary, these embodiments are provided for a more thorough and complete understanding of the present disclosure. It should be understood that the drawings and embodiments of the present disclosure are only used for illustrative purposes and are not used to limit the scope of protection of the present disclosure.

In the description of the embodiments of the present disclosure, the term "include/comprise" and similar terms should be understood as open-ended inclusions, that is, "include/comprise but not limited to". The term "based on" should be understood as "at least partially based on". The term "one embodiment" or "the embodiment" should be understood as "at least one embodiment". The terms "first", "second", etc. may refer to different or same objects. Other definitions, either explicit or implicit, may also be included below.

In some current live streaming rooms where audio and video processing links are inconsistent, audio comes from users, such as live streaming room hosts or guests, who join the room in real time, and video comes from images rendered in the cloud; moreover, the image rendering performed in the cloud relies on data obtained through local audio acquisition and calculation at a client. The audio stream of the host or the guest is pushed to the audience in real time, but the video stream has a certain delay after going through steps such as rendering in the cloud, which results in the lip movement of a virtual character that other users in the live streaming room see not being aligned with the audio. The coordination between the audio and the image is thus destroyed, resulting in a poor user experience.

For example, in a scenario of a virtual character live streaming room for a cloud game, in this scenario, the production ends of audio and video are inconsistent, and audio streams from a host and a guest on a microphone may be pushed to an audience side in real time, so the audio that the audience hears has no delay to some extent. However, a lip movement of a virtual character generated in the cloud needs to be rendered into a corresponding lip movement image that matches the audio, which takes a certain amount of time in the cloud. This may cause the audio stream and the video stream to be asynchronous on the audience side, greatly affecting the viewing experience of the audience.

To this end, an embodiment of the present disclosure provides a method for synchronizing an audio stream and a video stream. In this method, a computing device determines a target audio frame in an audio stream to be sent. In this case, the computing device may determine a set of durations corresponding to a set of historical video frames in a video stream for a set of historical audio frames in the audio stream. Then, a delay duration for the target audio frame is determined based on the determined duration of the set of historical video frames. Finally, the computing device delays the target audio frame by the calculated delay duration to keep the audio stream and the video stream synchronized. Through this method, an audio data packet sent in real time is delayed for a certain period of time to be sent, so that the time when the audio data packet and a video data packet arrive at a user viewing end is the same. An actual viewing effect is that an image is synchronized with audio, achieving an expected improvement objective and enhancing the user experience.

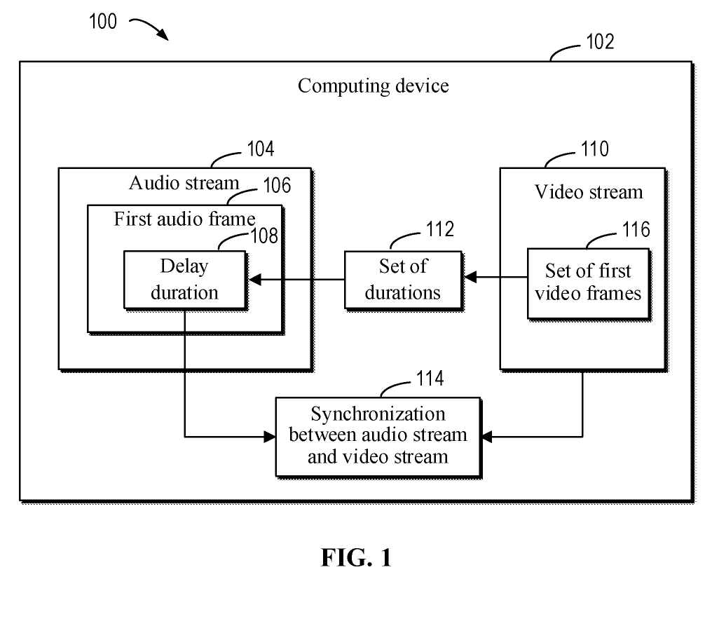

The embodiments of the present disclosure are described in detail below with further reference to the drawings. FIG. 1 illustrates an example environment in which a device and/or a method according to the embodiments of the present disclosure may be implemented. In environment 100, computing device 102 may synchronize an audio stream and a video stream.

Examples of computing device 102 include, but are not limited to, a personal computer, a server computer, a handheld or laptop device, a mobile device (such as a mobile phone, a personal digital assistant (PDA), a media player, etc.), a multi-processor system, a consumer electronic product, a minicomputer, a mainframe computer, a distributed computing environment including any of the above systems or devices, etc.

As shown in FIG. 1, computing device 102 may acquire audio stream 104. In a scenario where audio stream 104 needs to be synchronized with video stream 110, computing device 102 may first determine target audio frame 106 in audio stream 104 to be sent. In this case, computing device 102 may first acquire a user’s speech to obtain the required target audio frame in audio stream 104.

After acquiring locally collected audio data, computing device 102 may first process the audio data on the device to generate lip movement data, for example, lip movement identification data, that may be used for rendering, and then send the lip movement data corresponding to the audio frame to a target server. After receiving the lip movement data, a corresponding process in the target server generates video stream 110 having a lip movement image corresponding to the audio frame, and returns the video stream to computing device 102 or another device for sending through inter-process communication. For example, when live streaming a cloud game, a cloud game server may generate the video stream, where the video stream includes a virtual character, and a lip movement of the virtual character is driven by using the audio stream, for example, determined by the lip movement data corresponding to each audio frame in the audio stream. In an example, when computing device 102 is a device on a guest side in a live streaming room, the audio stream is an audio stream from a guest, and therefore audio stream 104 may also be provided to a live streaming end to be merged with video stream 110 for sending. In another example, computing device 102 may be a device on a host side, and in this case, the audio stream may be an audio stream from a host.

When sending the audio stream, computing device 102 may determine set of durations 112 corresponding to set of historical video frames 116 in video stream 110, where set of historical video frames 116 are generated based on a set of historical audio frames in the audio stream. When determining each duration in the set of durations, computing device 102 first determines a first timestamp for sending lip movement data corresponding to a historical video frame. For example, after determining the corresponding lip movement data by processing a historical audio frame, the lip movement data may be transmitted to a cloud game server, and a timestamp at which the lip movement data is uploaded at this time is recorded as the first timestamp. The lip movement data, after being uploaded to the server, may be used to generate a lip movement image in the historical video frame in video stream 110, and then the lip movement image is combined into the historical video frame and returned to computing device 102. Therefore, computing device 102 may further determine a second timestamp for receiving the historical video frame having the lip movement corresponding to the lip movement data. Finally, computing device 102 determines a duration corresponding to one historical video frame based on the first timestamp and the second timestamp.

A difference between the second timestamp and the first timestamp is a network round-trip duration for the lip movement data. For example, if the first timestamp for sending the lip movement data from the computing device is T1, and the second timestamp for acquiring the historical video frame having the lip movement corresponding to the lip movement data is T2, the corresponding duration is T2-T1. In addition, the duration corresponding to the historical audio frame corresponds to a sum of an upload duration of lip movement data of the historical audio frame, a generation duration of a lip movement image portion corresponding to the lip movement data, and a downstream duration of the historical video frame.

Through the above process, a temporal relationship between audio and video may be accurately determined, thereby implementing synchronous analysis of audio and video, and providing higher-precision control for subsequent alignment of the audio stream and the video stream.

Afterwards, computing device 102 determines delay duration 108 for target audio frame 106 based on set of durations 112 of set of historical video frames 116. The individual duration in set of durations 112 of the set of historical audio frames are not necessarily the same, and variations in which multiple duration values are different are affected by real-time round-trip time (RTT) in a network state. The higher the round-trip time, the longer the corresponding duration in set of durations 112 of the set of historical audio frames. Therefore, in order to make an audio delay duration better match most results and reduce errors, when determining delay duration 108 for target audio frame 106, an average duration in set of durations 112 is first calculated, and then delay duration 108 for target audio frame 106 is determined based on the average duration.

In some embodiments, when computing device 102 is a device of a guest in a live stream, when audio data is transmitted by computing device 102 to a device of a host, computing device 102 may obtain delay duration 108 for the audio frame by using the average duration plus a local calculation duration for generating the lip movement data for the audio frame and then subtracting a real-time communication duration to the host end. The local calculation duration and the real-time communication duration may be predetermined or calculated according to certain rules.

In some embodiments, when computing device 102 is a host device in a live stream, the delay duration 108 of a device to be sent to the guest side may also be determined by the computing device based on the average duration. In addition, computing device 102 generates a combined audio stream for a plurality of users based on the audio stream including target audio frame 106. The plurality of users include a guest participating in audio input. Meanwhile, the computing device delays the combined audio stream by the delay duration calculated above to obtain a delayed combined audio stream. After obtaining the combined audio stream, the computing device combines the corresponding audio stream and video stream and sends the combined stream to a client for viewing by a user.

The set of durations may be further updated with time, and a period for updating the set of durations is therefore set. If the period for updating the set of durations expires, computing device 102 continues to determine a second duration of a second video frame in the video stream, where the second video frame is generated based on a second audio frame in the audio stream. After the second duration of the video frame is determined, the set of durations in the queue is also updated with the second duration.

For example, when updating the set of durations, in order to ensure real-time performance and effectiveness of audio delay, the computing device may also maintain a queue that stores the set of durations to adjust the audio delay duration. Based on a first-in-first-out principle of the queue, a latest threshold number of round-trip delay duration results are retained in the queue, and a delay duration before the threshold number is dequeued. For example, after a latest round-trip delay duration is acquired, an earliest round-trip delay duration is dequeued, and then the average value of the round-trip delay in the queue is used to determine the audio packet sending delay.

Finally, computing device 102 keeps the audio stream and the video stream synchronized at block 114 by delaying target audio frame 106 by the calculated delay duration. In an example, the process of processing the delay may be different for the guest and the host in the live stream. As a main task of the guest is to send his or her own audio stream for merging processing, the audio and video synchronization requirement of the guest is for his or her own real-time communication audio processing, which only needs to ensure that the audio sent locally is aligned at the stream merging node. Therefore, the guest does not need to pay attention to the audio of other users. Therefore, when the user is a guest, his or her own real-time audio needs to be delayed. When the user is a host, the user not only needs to process the synchronization between his or her own real-time communication audio and video, but also needs to ensure overall alignment between all audio streams and video streams in the stream merging node. The audio of the host participates in merging to generate the final mixed stream. In order to ensure synchronization between audio and images of a plurality of users, the delay of the merged audio therefore needs to be additionally adjusted to ensure synchronization between audio and video of all users in the merging result. In this case, the audio and video on the guest side are aligned with the audio and video on the audience side, and both the audience side and the guest side have a good viewing experience.

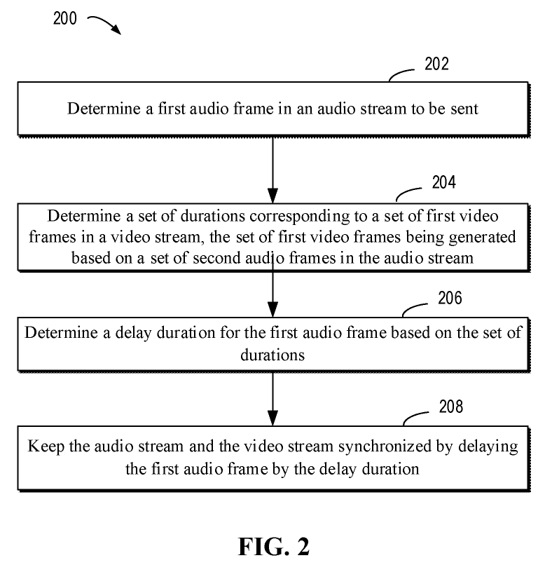

FIG. 1 above illustrates the schematic diagram of the example environment in which the device and/or the method of some embodiments of the present disclosure may be implemented. FIG. 2 below illustrates a schematic diagram of an example method for synchronizing an audio stream and a video stream according to some embodiments of the present disclosure. The method in FIG. 2 may be performed by computing device 102 in FIG. 1 or any suitable computing device.

As shown in FIG. 2, in example method 200, at block 202, computing device 102 determines a target audio frame in an audio stream to be sent. When computing device 102 performs signal acquisition on user audio, the user’s audio is converted into an analog signal and then into a digital signal by an audio processing module of computing device 102, and then continuous audio data is divided into multiple small blocks of fixed length, for example, each frame includes 10 milliseconds of audio data, and each small block is one frame. In an embodiment, the computing device generates audio frame F1 at 100 ms and generates audio frame F2 at 110 ms. In this case, if the device is preparing to send audio frame F2, F2 is the current target audio frame for the next operation, such as delaying for a specified duration.

At block 204, computing device 102 determines a set of durations corresponding to a set of historical video frames in a video stream, the set of historical video frames being generated based on a set of historical video frames in the audio stream. In order to synchronize the audio stream and the video stream, it is necessary to determine the set of durations based on a correspondence between historical audio frames and historical video frames. When processing an audio frame, the computing device needs to extract feature information of user speech, such as pronunciation lip movement data corresponding to the audio frame, generate related data for describing the lip movement based on these speech features, and record a time point at which the data is uploaded as a first timestamp. When the computing device receives a historical video frame corresponding to the lip movement in the video stream, a time point at which the video frame is successfully received or processed is recorded as a second timestamp. A time difference between the first timestamp and the second timestamp is calculated based on the first timestamp and the second timestamp, which is the duration corresponding to the historical video frame.

In addition, the duration corresponding to the historical video frame corresponds to a sum of an upload duration of the lip movement data, a generation duration of the lip movement image portion of the lip movement data, and a downstream duration of the historical video frame. The sum of the upload duration of the lip movement data of the historical audio frame, the generation duration of the lip movement image portion of the lip movement data, and the downstream duration of the historical video frame is the time consumed by the lip movement generation link, and the time consumed dynamically changes in response to round-trip time (RTT). For example, in an embodiment, it takes 20 ms to locally process an audio frame, a network delay is 50 ms in an uploading process, it takes 100 ms to generate a video frame, and it takes 40 ms to transmit the video frame. In this case, the total duration is 210 ms, and the time consumed by the lip movement generation link is 190 ms. When it takes a fixed 10 ms for audio real-time communication (RTC) transmission, the audio delay duration is 200 ms. After adjustment, the audio stream and the video stream are approximately aligned on the audience side.

At block 206, computing device 102 determines a delay duration for the target audio frame based on the set of durations. In order to ensure synchronization between the audio stream and the video stream, it is necessary to calculate the delay duration for each target audio frame. The delay duration is determined based on analysis of the duration set of the historical video frames and audio frames to dynamically adjust the delay, thereby adapting to network fluctuations and processing delays.

After obtaining the duration queue for historical audio or historical video of multiple past frames, computing device 102 calculates the average duration by using the duration queue, and then determines the delay duration for audio delay by using the obtained average duration. The obtained target video frame includes lip movement information corresponding to speech content of the target audio frame, ensuring that a lip movement action in the video image matches the audio content. Through the method of calculating the average duration based on historical data, the delay duration of the target audio frame may be dynamically adjusted to adapt to different networks and processing environments.

When the computing device is a host end, in the case of audio input from multiple users, it is necessary to generate a combined audio stream for sending to other viewers. The combined audio stream is an audio data stream generated by superimposing or mixing audio data streams of multiple users in chronological order. When outputting the combined audio stream, it is also possible to delay the combined audio stream for a specified time based on the calculated delay duration to keep the combined audio stream synchronized with the video. In an embodiment, in a live streaming environment including A, B, and C, the computing device needs to first acquire audio streams of the three, and synthesize a combined audio stream including all users. Then the delay duration is calculated and applied to synchronize the audio and the video, and real-time video frames of the users are combined into a video stream, and the combined audio stream and the video stream are synchronously sent to each client, so that synchronization between the audio and the video may be ensured when the client plays the audio and the video.

In addition, computing device 102 may use the extracted target audio frame to generate lip movement data matching the target audio frame, and then upload the lip movement data to the cloud or a server for generating the target video frame. Data processing and synchronization are implemented through interaction with the cloud or the server. The server generates the target video frame based on target lip movement identification data, including dynamic matching of mouth movements. The host end receives the target video frame and synchronizes the target video frame with the target audio frame.

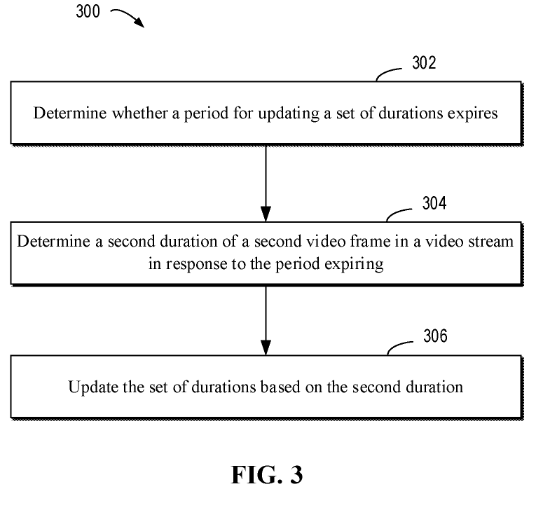

At block 208, the audio stream and the video stream are kept synchronized by delaying the target audio frame by the calculated delay duration. In the process of synchronizing the audio stream and the video stream, dynamic updating is required to adapt to changes in network conditions and processing performance. In this process, dynamic updating may also be implemented by updating the set of durations, which is described below with reference to FIG. 3.

Through the above method, precise synchronization between the audio stream and the video stream in a multi-user scenario may be achieved, and dynamic adaptation to network duration fluctuations and performance changes may be achieved, providing users with a high-quality audio and video synchronization experience.

FIG. 2 above illustrates the schematic diagram of the example method for synchronizing an audio stream and a video stream according to some embodiments of the present disclosure. The set of durations described above may be updated periodically. FIG. 3 below illustrates a schematic diagram of an example method for updating a duration according to some embodiments of the present disclosure. The method in FIG. 3 may be performed by computing device 102 in FIG. 1 or any suitable computing device.

In example 300, at block 302, computing device 102 determines whether a period for updating the set of durations expires. For example, the system periodically checks whether the set of durations needs to be updated, and the period may be manually or automatically adjusted in the background. For example, the period may be set to 180 seconds.

At block 304, computing device 102 determines a second duration of a second video frame in the video stream in response to the period expiring, the second video frame being generated based on a second audio frame in the audio stream. After the set period for updating expires, the second duration related to the audio frame and the generated video frame at this time may be further determined.

At block 306, computing device 102 updates the set of durations based on the second duration. After obtaining the second duration, computing device 102 may update the set of durations based on the second duration.

When updating the set of durations with the second duration, computing device 102 may determine whether the number of durations in the set of durations is less than a threshold number. For example, if the threshold number of durations in the set of durations is 10, that is, the set of durations holds at most 10 durations. Computing device 102 may determine the number of the set of durations at this time, and then compare the number with the threshold number.

If the number of durations in the set of durations is less than the threshold number, computing device 102 adds the second duration to the set of durations. For example, there are already 8 durations in the set of durations, which is less than the threshold number 10. In this case, the obtained duration may be directly added to the set of durations.

If computing device 102 determines that the number of durations in the set of durations is greater than or equal to the threshold number, it indicates that the number of durations in the set of data at this time has met the requirement. At this time, computing device 102 removes an earliest obtained duration in the set of durations. For example, the duration that enters the set of data at the earliest time. Then, computing device 102 adds the second duration to the set of durations. Therefore, a new video frame delay duration may be calculated by updating the duration queue.

For example, the set of durations may be put into a dynamically maintained RTT queue based on a first-in-first-out design principle, and latest N RTT measurement results are retained. The audio packet sending delay of the user using the virtual character is dynamically updated with a period of time T. In a service for the virtual character, N is set to 10 according to evaluation. In this case, the queue is rttQueue = [RTT1, RTT2, ..., RTTn], and may be updated periodically.

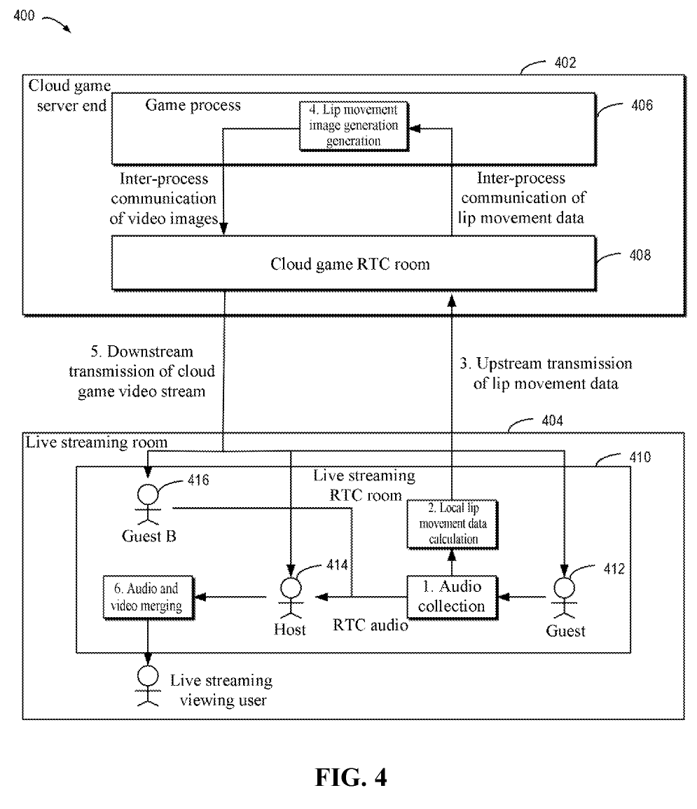

FIG. 3 above illustrates the schematic diagram of the example method for updating a duration according to some embodiments of the present disclosure. FIG. 4 below illustrates a schematic diagram of an example process of a lip movement generation link according to some embodiments of the present disclosure.

In example 400, there are a cloud game server end 402 and a live streaming room 404. After audio collection is performed by a computing device on audio from a guest 412 in a live streaming RTC room 410 in the live streaming room 404, audio data is converted into lip movement data that may be used for rendering after local lip movement data calculation is performed, and then the lip movement data is uploaded to a cloud game RTC room 408. The lip movement data transmitted to the cloud game RTC room 408 at this time is lip movement identification data, and the lip movement identification data is mapped based on vowels. The lip movement data in the cloud game room generates a lip movement image in a game process 406 through inter-process communication and reaches the cloud game RTC room 408 through inter-process communication. The cloud game RTC room 408 pushes a video stream including the lip movement data to each guest side in the live streaming RTC room 410 of the live streaming room 404, that is, the guest 412, a host 414, and a guest 416 in the figure, through downstream transmission of a cloud game video stream. Meanwhile, the audio collected at an audio collection end is also delayed by the audio delay duration calculated through the delay. When the guest is a virtual character, only the RTC audio needs to be delayed after audio collection. When the host is a virtual character, the host needs to delay all RTC audio and merged audio.

Therefore, the lip movement generation link is as shown above. In order to align the lip movement of the virtual character with the voice, it is necessary to perform packet sending delay on the RTC audio of the user using the virtual character. The audio packet sending delay time + the RTC audio transmission time is approximately equal to the local lip movement data calculation duration + the lip movement data upload duration + the lip movement image generation duration + the cloud game video downstream duration, thereby achieving the effect of approximate alignment between the lip movement and the audio. The time consumed by the RTC audio transmission may be a fixed constant based on the average time consumed by a live streaming platform, and the time consumed by the lip movement generation link needs to be dynamically measured.

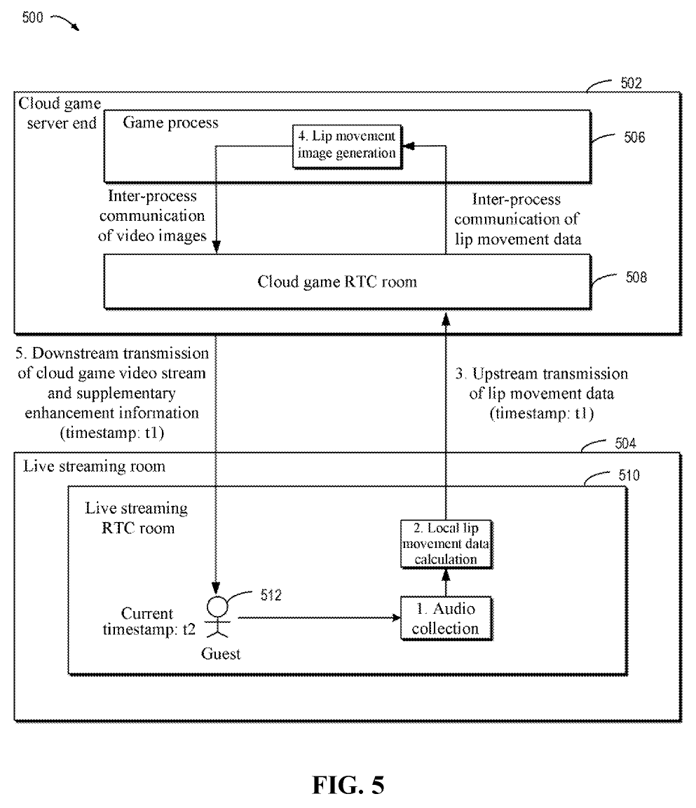

FIG. 4 above illustrates the schematic diagram of the example method of the lip movement generation link according to some embodiments of the present disclosure. FIG. 5 below illustrates a schematic diagram of another example process of round-trip delay of a lip movement generation link according to some embodiments of the present disclosure.

In example 500, there are a cloud game server end 502 and a live streaming room 504. A guest 512 in a live streaming RTC room 510 makes a sound, and a computing device first performs audio collection at step 1 and then performs local calculation at step 2. At step 3, the lip movement data obtained through calculation is uploaded to the cloud game server end 502, for example, uploaded to a cloud game RTC room 508 of the cloud game server end 502, and meanwhile, the current lip movement data upstream timestamp t1 is recorded at step 3. Then, through inter-process communication with the cloud game RTC room 508, lip movement image generation is performed at step 4 in a game process 506. Then, a video image having a lip movement image is transmitted to the cloud game RTC room 508 via the inter-process communication. At step 5, the generated cloud game video stream is sent downstream, and supplementary enhancement information is added. The supplementary enhancement information carries the timestamp information at step 3. Finally, the video stream carrying the lip movement image is returned to the guest 512, and the current timestamp t2 is recorded. Therefore, the round-trip time (RTT) value of this frame is t2-t1. Then, the round-trip delay value is put into an RTT queue to prepare for subsequent calculation of an average round-trip delay value and dynamic maintenance.

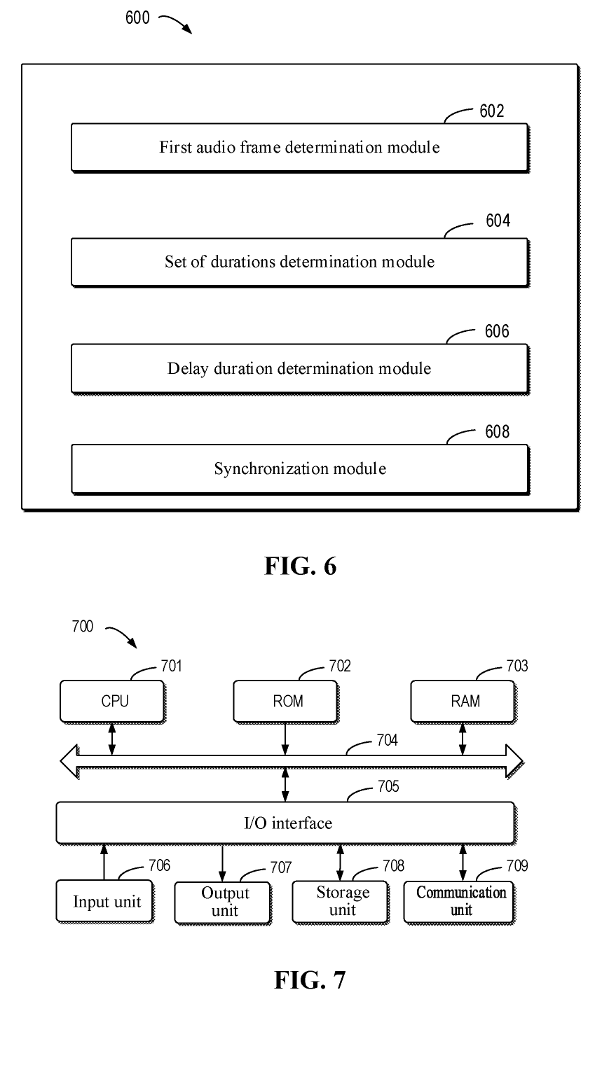

FIG. 6 illustrates a schematic block diagram of an apparatus for synchronizing an audio stream and a video stream according to some embodiments of the present disclosure. As shown in FIG. 6, apparatus 600 includes target audio frame determination module 602 configured to determine a target audio frame in an audio stream to be sent; a set of durations determination module 604 configured to determine a set of durations corresponding to a set of historical video frames in a video stream, the set of historical video frames being generated based on a set of historical audio frames in the audio stream; delay duration determination module 606 configured to determine a delay duration for the target audio frame based on the set of durations; and synchronization module 608 configured to keep the audio stream and the video stream synchronized by delaying the target audio frame by the delay duration.

In some embodiments, target audio frame determination module 602 includes an acquisition module configured to perform audio collection on a user’s speech to obtain the target audio frame in the audio stream.

In some embodiments, a set of durations determination module 604 includes a first timestamp determination module configured to determine a first timestamp for sending lip movement data corresponding to a historical audio frame in the set of historical audio frames; a first timestamp determination module configured to determine a second timestamp for receiving a historical video frame, which has a lip movement corresponding to the lip movement data, in the set of historical video frames; and a duration determination module configured to determine a duration corresponding to the historical video frame based on the first timestamp and the second timestamp.

In some embodiments, the duration determination module includes a difference determination module configured to determine a timestamp difference between the second timestamp and the first timestamp; and a first duration determination module configured to determine the timestamp difference as the duration corresponding to the historical video frame.

In some embodiments, the duration corresponds to a sum of an upload duration of the lip movement data, a generation duration of a lip movement image portion corresponding to the lip movement data, and a downstream duration of the historical video frame.

In some embodiments, delay duration determination module 606 includes an average duration determination module configured to determine an average duration of the set of durations based on the set of durations; and a first delay duration determination module configured to determine the average duration as the delay duration for the target audio frame.

In some embodiments, the target video frame includes a lip movement corresponding to the target audio frame.

In some embodiments, apparatus 600 further includes a combined audio stream generation module configured to generate a combined audio stream for a plurality of users based on the audio stream including the target audio frame; a delayed audio stream module configured to acquire a delayed combined audio stream by delaying the combined audio stream by the delay duration; and a sending module configured to combine the delayed combined audio stream and a combined video stream formed by the video stream to send to a client.

In some embodiments, apparatus 600 further includes a lip movement generation module configured to generate target lip movement data corresponding to the target audio frame based on the target audio frame; a lip movement data sending module configured to send the target lip movement data to a target server; and a video frame receiving module configured to receive, from the target server, a target video frame including a lip movement corresponding to the target lip movement data.

In some embodiments, the target audio frame is a first audio frame, and apparatus 600 further includes a period detection module configured to determine whether a period for updating the set of durations expires; a second duration determination module configured to determine a second duration of a second video frame in the video stream in response to the period expiring, the second video frame being generated based on a second audio frame in the audio stream; and an update module configured to update the set of durations based on the second duration.

In some embodiments, the update module includes a number determination module configured to determine whether the number of durations in the set of durations is less than a threshold number; and a first addition module configured to add the second duration to the set of durations in response to the number of durations in the set of durations being less than the threshold number.

In some embodiments, the update module further includes a removal module configured to remove an earliest obtained duration in the set of durations in response to determining that the number of durations in the set of durations is greater than or equal to the threshold number; and a second addition module configured to add the second duration to the set of durations.

In some embodiments, the audio stream comes from a host or a guest who performs live streaming of a cloud game, the video stream is a video stream of the cloud game, and a lip movement of a virtual character in the cloud game is driven by using the audio stream.

FIG. 7 illustrates a schematic block diagram of an example device 700 that may be used to implement the embodiments of the present disclosure. Computing device 102 in FIG. 1 may be implemented by using device 700. As shown in the figure, device 700 includes a central processing unit (CPU) 701 that may perform various suitable actions and processing according to computer program instructions stored in a read-only memory (ROM) 702 or computer program instructions loaded from a storage unit 708 into a random access memory (RAM) 703. In the RAM 703, various programs and data required for operations of the device 700 may also be stored. The CPU 701, the ROM 702, and the RAM 703 are connected to each other through a bus 704. An input/output (I/O) interface 705 is also connected to the bus 704.

Multiple components in the device 700 are connected to the I/O interface 705, and the components include an input unit 706, such as a keyboard and a mouse; an output unit 707, such as various types of displays and speakers; the storage unit 708, such as a magnetic disk and an optical disc; and a communication unit 709, such as a network card, a modem, and a wireless communication transceiver. The communication unit 709 allows the device 700 to exchange information/data with other devices over a computer network such as Internet and/or various telecommunication networks.

The various processes and treatments described above, such as methods 200 and 300, may be performed by processing unit 701. For example, in some embodiments, methods 200 and 300 may be implemented as computer software programs tangibly contained in a machine-readable medium, such as storage unit 708. In some embodiments, a portion or an entirety of the computer program may be loaded and/or installed into device 700 via ROM 702 and/or communication unit 709. When the computer program is loaded into RAM 703 and executed by CPU 701, one or more actions of example methods 200 and 300 described above may be performed.

The present disclosure may be a method, an apparatus, a system, and/or a computer program product. The computer program product may include a computer-readable storage medium having computer-readable program instructions stored thereon for performing various aspects of the present disclosure.

The computer-readable storage medium may be a tangible device that may hold and store instructions used by an instruction execution device. The computer-readable storage medium may be, for example, but is not limited to, an electrical storage device, a magnetic storage device, an optical storage device, an electromagnetic storage device, a semiconductor storage device, or any suitable combination thereof. More specific examples (a non-exhaustive list) of the computer-readable storage medium include: a portable computer disk, a hard disk, a random access memory (RAM), a read-only memory (ROM), an erasable programmable read-only memory (EPROM or flash memory), a static random access memory (SRAM), a portable compact disc read-only memory (CD-ROM), a digital versatile disc (DVD), a memory stick, a floppy disk, a mechanically encoded device, such as a punched card or a raised structure in a groove having instructions stored thereon, and any suitable combination thereof. The computer-readable storage medium used herein is not interpreted as an instantaneous signal itself, such as a radio wave or other freely propagating electromagnetic waves, electromagnetic waves propagating through a waveguide or other transmission media (for example, light pulses through an optical fiber cable), or electrical signals transmitted through wires.

The computer-readable program instructions described herein may be downloaded from the computer-readable storage medium to various computing/processing devices, or downloaded to an external computer or an external storage device through a network, such as Internet, a local area network, a wide area network, and/or a wireless network. The network may include a copper transmission cable, an optical fiber transmission, a wireless transmission, a router, a firewall, a switch, a gateway computer, and/or an edge server. A network adapter card or a network interface in each computing/processing device receives the computer-readable program instructions from the network and forwards the computer-readable program instructions for storage in a computer-readable storage medium in the various computing/processing devices.

The computer program instructions for performing the operations of the present disclosure may be assembly instructions, instruction set architecture (ISA) instructions, machine instructions, machine-related instructions, microcode, firmware instructions, state setting data, or source code or object code written in any combination of one or more programming languages, the programming languages including object-oriented programming languages, such as Smalltalk, C++, etc., and conventional procedural programming languages, such as "C" language or similar programming languages. The computer-readable program instructions may be executed entirely on a user’s computer, partly executed on a user’s computer, executed as an independent software package, partly executed on a user’s computer and partly executed on a remote computer, or entirely executed on a remote computer or a server. In the case involving a remote computer, the remote computer may be connected to a user’s computer through any kind of network, including a local area network (LAN) or a wide area network (WAN), or may be connected to an external computer (for example, connected through Internet by using Internet service provider). In some embodiments, by customizing an electronic circuit, such as a programmable logic circuit, a field programmable gate array (FPGA) or a programmable logic array (PLA), using status information of the computer-readable program instructions, the electronic circuit may execute the computer-readable program instructions, thereby implementing various aspects of the present disclosure.

Various aspects of the present disclosure are described herein with reference to flowcharts and/or block diagrams of methods, apparatuses (systems), and computer program products according to embodiments of the present disclosure. It should be understood that each block of the flowchart and/or block diagram, and a combination of blocks in the flowchart and/or block diagram may be implemented by computer-readable program instructions.

These computer-readable program instructions may be provided to a processing unit of a general-purpose computer, a dedicated computer, or other programmable data processing apparatus to produce a machine, such that the instructions, when executed by the processing unit of the computer or other programmable data processing apparatus, produce an apparatus for implementing a function/action specified in one or more blocks of the flowchart and/or block diagram. These computer-readable program instructions may also be stored in a computer-readable storage medium, and the instructions cause a computer, a programmable data processing apparatus, and/or other device to operate in a specific manner. Thus, the computer-readable medium having the instructions stored therein includes a manufactured product, which includes instructions for implementing various aspects of the function/action specified in one or more blocks of the flowchart and/or block diagram.

The computer-readable program instructions may also be loaded onto a computer, another programmable data processing apparatus, or another device, such that a series of operations and steps are performed on the computer, another programmable data processing apparatus, or another device to produce a computer-implemented process. Thus, the instructions executed on the computer, another programmable data processing apparatus, or another device implement the function/action specified in one or more blocks of the flowchart and/or block diagram.

The flowchart and block diagram in the drawings illustrate the possibly implemented architectures, functions, and operations of the system, the method, and the computer program product according to multiple embodiments of the present disclosure. In this regard, each block in the flowchart or block diagram may represent a module, a program segment, or a portion of instruction, and the module, the program segment, or the portion of instruction contains one or more executable instructions for implementing the specified logical function. In some alternative implementations, the functions marked in the blocks may also occur in an order different from that marked in the drawings. For example, two consecutive blocks may actually be performed substantially in parallel, or they may sometimes be performed in a reverse order, depending on the functions involved. It should also be noted that each block in the block diagram and/or the flowchart, and the combination of the blocks in the block diagram and/or the flowchart may be implemented by a dedicated hardware-based system that executes a specified function or action, or may be implemented by a combination of dedicated hardware and computer instructions.

The embodiments of the present disclosure have been described above. The above description is exemplary, non-exhaustive, and is not intended to limit the disclosed embodiments. Without departing from the scope and spirit of the described embodiments, many modifications and variations will be apparent to those of ordinary skill in the art. The terms used herein are intended to best explain the principles, actual applications, or technical improvements of the technology in the market of the embodiments, or to enable other persons of ordinary skill in the art to understand the embodiments disclosed herein.

We claim:

1. A method for synchronizing an audio stream and a video stream, comprising:
determining a first audio frame in an audio stream to be sent;
determining a set of durations corresponding to a set of first video frames in a video stream, the set of first video frames being generated based on a set of second audio frames in the audio stream;
determining a delay duration for the first audio frame based on the set of durations; and
keeping the audio stream and the video stream synchronized by delaying the first audio frame by the delay duration.

2. The method of claim 1, wherein determining the first audio frame in the audio stream to be sent comprises:
performing audio collection on a user’s speech to obtain the first audio frame in the audio stream.

3. The method of claim 1, wherein determining the set of durations corresponding to the set of first video frames in the video stream comprises:
determining a first timestamp for sending lip movement data corresponding to a second audio frame in the set of second audio frames;
determining a second timestamp for receiving a first video frame, which has a lip movement corresponding to the lip movement data, in the set of first video frames; and
determining a duration corresponding to the first video frame based on the first timestamp and the second timestamp.

4. The method of claim 3, wherein determining the duration corresponding to the first video frame based on the first timestamp and the second timestamp comprises:
determining a timestamp difference between the second timestamp and the first timestamp; and
determining the timestamp difference as the duration corresponding to the first video frame.

5. The method of claim 4, wherein the duration corresponds to a sum of an upload duration of the lip movement data, a generation duration of a lip movement image portion corresponding to the lip movement data, and a downstream duration of the first video frame.

6. The method of claim 1, wherein determining the delay duration for the first audio frame based on the set of durations comprises:
determining an average duration of the set of durations based on the set of durations; and
determining the average duration as the delay duration for the first audio frame.

7. The method of claim 1, wherein a second video frame comprises a lip movement corresponding to the first audio frame.

8. The method of claim 1, further comprising:
generating a combined audio stream for a plurality of users based on the audio stream comprising the first audio frame;
acquiring a delayed combined audio stream by delaying the combined audio stream by the delay duration; and
combining the delayed combined audio stream and a combined video stream formed by the video stream for sending to a client.

9. The method of claim 1, further comprising:
generating lip movement data corresponding to the first audio frame based on the first audio frame;
sending the lip movement data to a server; and
receiving, from the server, a second video frame comprising a lip movement corresponding to the lip movement data.

10. The method of claim 1, wherein the first audio frame is a first audio frame, and the method further comprises:
determining whether a period for updating the set of durations expires;
determining a second duration of a second video frame in the video stream in response to the period expiring, the second video frame being generated based on a second audio frame in the audio stream; and
updating the set of durations based on the second duration.

11. The method of claim 10, wherein updating the set of durations based on the second duration comprises:
determining whether a number of durations in the set of durations is less than a threshold number; and
adding the second duration to the set of durations in response to the number of the durations in the set of durations being less than the threshold number.

12. The method of claim 11, wherein updating the set of durations based on the second duration further comprises:
removing an earliest obtained duration in the set of durations in response to determining that the number of the durations in the set of durations is greater than or equal to the threshold number; and
adding the second duration to the set of durations.

13. The method of claim 1, wherein the audio stream comes from a streamer or a guest who performs live streaming of a cloud game, the video stream is a video stream of the cloud game, and a lip movement of a virtual character in the cloud game is driven by using the audio stream.

14. An electronic device, comprising:
at least one processor; and
a storage, configured to store at least one program, wherein the at least one program, when executed by the at least one processor, causes the electronic device to:
determine a first audio frame in an audio stream to be sent;
determine a set of durations corresponding to a set of first video frames in a video stream, the set of first video frames being generated based on a set of second audio frames in the audio stream;
determine a delay duration for the first audio frame based on the set of durations; and
keep the audio stream and the video stream synchronized by delaying the first audio frame by the delay duration.

15. The electronic device according to claim 14, wherein the at least one processor causing the device to determine the first audio frame in the audio stream to be sent further causes the device to:
perform audio collection on a user’s speech to obtain the first audio frame in the audio stream.

16. The electronic device according to claim 14, wherein the at least one processor causing the device to determine the set of durations corresponding to the set of first video frames in the video stream further causes the device to:
determine a first timestamp for sending lip movement data corresponding to a second audio frame in the set of second audio frames;
determine a second timestamp for receiving a first video frame, which has a lip movement corresponding to the lip movement data, in the set of first video frames; and
determine a duration corresponding to the first video frame based on the first timestamp and the second timestamp.

17. The electronic device according to claim 16, wherein the at least one processor causing the device to determine the duration corresponding to the first video frame based on the first timestamp and the second timestamp further causes the device to:
determine a timestamp difference between the second timestamp and the first timestamp; and
determine the timestamp difference as the duration corresponding to the first video frame.

18. The electronic device according to claim 17, wherein the duration corresponds to a sum of an upload duration of the lip movement data, a generation duration of a lip movement image portion corresponding to the lip movement data, and a downstream duration of the first video frame.

19. The electronic device according to claim 14, wherein the at least one processor causing the device to determine the delay duration for the first audio frame based on the set of durations further causes the device to:
determine an average duration of the set of durations based on the set of durations; and
determine the average duration as the delay duration for the first audio frame.

20. A non-transitory computer-readable storage medium having a computer program stored thereon, wherein the computer program, when executed by a processor, causes a computer to:
determine a first audio frame in an audio stream to be sent;
determine a set of durations corresponding to a set of first video frames in a video stream, the set of first video frames being generated based on a set of second audio frames in the audio stream;
determine a delay duration for the first audio frame based on the set of durations; and
keep the audio stream and the video stream synchronized by delaying the first audio frame by the delay duration.
